(19) United States
(12) Patent Application Publication
(10) Pub. No.: US 2011/0228806 A1
(43) Pub. Date: Sep. 22, 2011

(54) FIBER LASER

(75) Inventor: Shin Masuda, Miyagi (JP)

(73) Assignee: ADVANTEST CORPORATION, Tokyo (JP)

(21) Appl. No.: 13/122,459

(22) PCT Filed: Oct. 14, 2009
(86) PCT No.: PCT/JP2009/068089

§ 371 Date: May 12, 2011

(30) Foreign Application Priority Data
Oct. 15, 2008 (JP) 2008-266703

(51) Int. Cl. H01S 3/091

(52) U.S. Cl. 372/70

(57) ABSTRACT

In a fiber laser, a stable laser oscillation is easily realized. A fiber laser includes an optical amplification unit which has a first end and a second end, receives pump light, and emits spontaneous emission light from the first end, and receives the spontaneous emission light at the second end, and emits stimulated emission light from the first end, and a light passing unit (PM fibers, single mode fiber) which connects the first end and the second end with each other, and passes the spontaneous emission light and the stimulated emission light, where the light passing unit includes the PM fibers (polarization plane maintaining units) which present a small change in the polarization plane of passing light and a single mode fiber (polarization plane changing unit) which presents a large change in the polarization plane of passing light.

### TECHNICAL FIELD

The present invention relates to a fiber laser

### BACKGROUND ART

The fiber laser has conventionally been known. In the fiber laser, pump light is fed to an EDF (Erbium Doped Fiber) in a resonator, for example. Spontaneous emission light is then emitted from one end of the EDF. The end and the other end of the EDF is connected by an optical fiber thereby forming a ring resonator, and a positive feedback of the EDF is provided by returning the spontaneous emission light back to the other end thereby providing a circulation in the resonator, resulting in a laser oscillation. Moreover, an analyzer is inserted in the resonator for maintaining the polarization plane of the laser oscillation light.

A condition in which the polarization plane of the laser oscillation light transmitting through the analyzer matches the polarization plane of the analyzer is necessary for stable laser oscillation on this occasion. However, interference (such as a variation in the environmental temperature) may cause a case in which the polarization plane of the analyzer and the polarization plane of the laser oscillation light do not match.

In order to address this problem, it is known to insert a polarization controller into the optical fiber which connects one end and the other end of the EDF with each other, and to make adjustment so that the polarization planes match, thereby providing a stable operation (refer to FIG. 2 of a non-patent document 1, and FIG. 1 of a non-patent document 2, for example).

(Non-patent document 1) Eiji Yoshida et. al., “Femtosecond Erbium-Doped Fiber Laser with Nonlinear Polarization Rotation and Its Soliton Compression”, Jpn. J. Appl. Phys, Vol. 33 (1994), pp. 5779-5783

(Non-patent document 2) K. Tamura et. al., “77-fs pulse generation from a stretched-pulse mode-locked all-fiber ring laser”, OPTICS LETTERS, Vol. 18, No. 13, Jul. 1, 1993

However, according to the prior art as described above, a fine adjustment of the polarization planes by the polarization controller is necessary, and this fine adjustment requires a large amount of labor.

It is therefore an object of the present invention to easily realize a stable laser oscillation.

### DISCLOSURE OF THE INVENTION

According to the present invention, a fiber laser includes: an optical amplification unit that has a first end and a second end, receives pump light, and emits spontaneous emission light from the first end, and receives the spontaneous emission light at the second end, and emits stimulated emission light from the first end; and a light passing unit that connects the first end and the second end with each other, and passes the spontaneous emission light and stimulated emission light, wherein the light passing unit includes: a polarization plane maintaining unit that presents a small change in the polarization plane of the passing light according to a change in the wavelength of the passing light; and a polarization plane changing unit that presents a large change in the polarization plane of the passing light according to a change in the wavelength of the passing light.

According to the thus constructed fiber laser, an optical amplification unit has a first end and a second end, receives pump light, and emits spontaneous emission light from the first end, and receives the spontaneous emission light at the second end, and emits stimulated emission light from the first end. A light passing unit connects the first end and the second end with each other, and passes the spontaneous emission light and stimulated emission light. The light passing unit includes: a polarization plane maintaining unit that presents a small change in the polarization plane of the passing light according to a change in the wavelength of the passing light; and a polarization plane changing unit that presents a large change in the polarization plane of the passing light according to a change in the wavelength of the passing light.

According to the fiber laser of the present invention, the polarization plane maintaining unit may be a first polarization plane maintaining fiber.

According to the fiber laser of the present invention, the polarization plane changing unit may be an optical fiber that includes a first circulation unit which is circled with a radius of a predetermined length.

According to the fiber laser of the present invention, the polarization plane changing unit may be an optical fiber that further includes a second circulation unit which is circled with a radius shorter than the predetermined length.

According to the fiber laser of the present invention, the polarization plane changing unit may be a double refraction material.

According to the fiber laser of the present invention, the polarization plane changing unit may include a second polarization plane maintaining fiber that has a polarization axis different from a polarization axis of the first polarization plane maintaining fiber.

According to the fiber laser of the present invention, the polarization plane changing unit may further include a third polarization plane maintaining fiber that has a polarization axis different from the polarization axes of the first polarization plane maintaining fiber and the second polarization plane maintaining fiber.

According to the present invention, the fiber laser may include an analyzer that allows only light having a predetermined polarization plane to pass, wherein the polarization plane changing unit includes a fourth polarization plane maintaining fiber that has a polarization axis different from the polarization axis of the analyzer.

According to the fiber laser of the present invention, the optical amplification unit and the polarization plane changing unit may be unified.

According to the present invention, the fiber laser may include: a pump light source that emits the pump light; a first coupler that allows the pump light to pass toward the first end, and allows the light emitted from the first end to pass toward the second end; a second coupler that splits the light passing through the polarized plane maintaining unit toward the second end and the outside; and an analyzer that allows only light having a predetermined polarization plane to pass, wherein the polarization plane maintaining unit includes an isolator that passes the light emitted from the first end toward the second end, and does not pass the light emitted from the second end toward the first end.

### BRIEF DESCRIPTION OF THE DRAWINGS

FIG. 1 is a diagram showing a configuration of a fiber laser 1 according to a first embodiment of the present invention;

FIG. 2 describes effects of the single mode fiber (polarization plane changing unit) 24;

FIG. 3 is a diagram showing a configuration of the fiber laser 1 according to the second embodiment of the present invention;

FIG. 4 is a diagram showing a configuration of the fiber laser 1 according to the third embodiment of the present invention;

FIG. 5 is a diagram showing a configuration of the fiber laser 1 according to the fourth embodiment of the present invention;

FIG. 6 is a diagram showing a configuration of the fiber laser 1 according to the fifth embodiment of the present invention;

FIG. 7 is a diagram showing a configuration of the fiber laser 1 according to the sixth embodiment of the present invention;

FIG. 8 is a diagram showing a configuration of the fiber laser 1 according to the seventh embodiment of the present invention; and

FIG. 9 is a chart describing the principle of the stable oscillation.

### BEST MODE FOR CARRYING OUT THE INVENTION

A description will now be given of embodiments of the present invention referring to drawings.

### First Embodiment

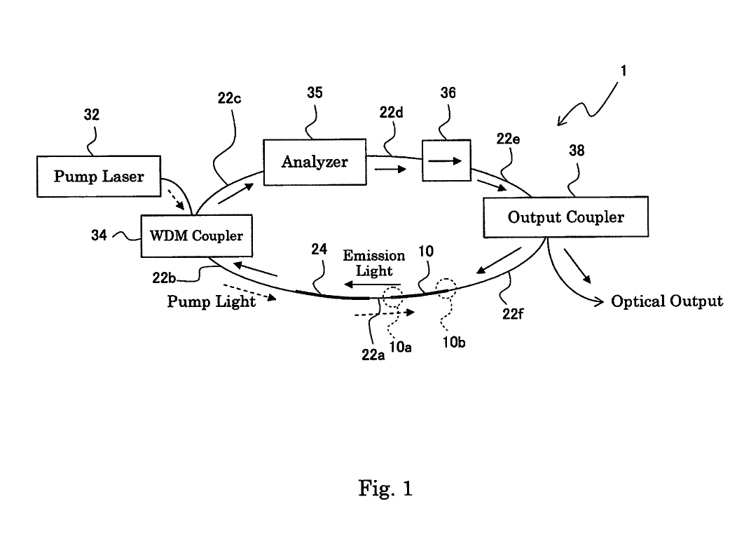

FIG. 1 is a diagram showing a configuration of a fiber laser 1 according to a first embodiment of the present invention. The fiber laser 1 according to the first embodiment includes an EDF (Erbium Doped Fiber) (optical amplification unit) 10, PM fibers (polarization plane maintaining units) 22a, 22b, 22c, 22d, 22e, 22f, a single mode fiber (polarization plane changing unit) 24, a pump laser (pump light source) 32, a WDM coupler (first coupler) 34, an analyzer 35, an isolator 36, an output coupler (second coupler) 38.

The EDF (Erbium Doped Fiber) (optical amplification unit) 10 includes a first end 10a and a second end 10b. The first end 10a is a left end of the EDF 10, and a second end 10b is a right end of the EDF 10 in FIG. 1.

The PM fibers (polarization plane maintaining units) 22a, 22b, 22c, 22d, 22e, 22f present a small change (preferable as small as negligible) in the polarization plane of light passing therethrough with respect to a change in the wavelength of the light passing therethrough. It should be noted that these PM fibers are first polarization plane maintaining fibers.

The single mode fiber (polarization plane changing unit) 24 presents a larger change in the polarization plane of light passing therethrough with respect to a change in the wavelength of the light passing therethrough compared with the PM fibers. It is conceivable to unify the EDF 10 and the single mode fiber 24.

It should be noted that the PM fibers (polarization plane maintaining units) 22a, 22b, 22c, 22d, 22e, 22f and the single mode fiber (polarization plane changing unit) 24 correspond to a light passing unit, and connect the first end 10a and the second end 10b of the EDF 10 with each other. Spontaneous emission light and stimulated emission light emitted by the EDF 10 pass through the PM fibers 22a, 22b, 22c, 22d, 22e, 22f and the single mode fiber (polarization plane changing unit) 24. It should be noted that the WDM coupler 34, the analyzer 35, the isolator 36, and the output coupler 38 are inserted in intervals of the PM fibers 22b, 22c, 22d, 22e, 22f.

Specifically, the PM fiber 22a connects the first end 10a of the EDF 10 and the single mode fiber 24 with each other. The PM fiber 22b connects the single mode fiber 24 and the WDM coupler 34 with each other. The PM fiber 22c connects the WDM coupler 34 and the analyzer 35 with each other. The PM fiber 22d connects the analyzer 35 and the isolator 36 with each other. The PM fiber 22e connects the isolator 36 and the output coupler 38 with each other. The PM fiber 22f connects the output coupler 38 and the second end 10b of the EDF 10 with each other.

The pump laser (pump light source) 32 emits pump light.

The WDM coupler (first coupler) 34 passes the pump light toward the first end 10a, and passes the light (spontaneous emission light and stimulated emission light) emitted from the first end 10a toward the second end 10b.

The analyzer 35 passes only light having a predetermined polarization plane.

The isolator 36 passes the light emitted from the first end 10a toward the second end 10b. However, the isolator 36 does not pass the light (spontaneous emission light and stimulated emission light) emitted from the second end 10b toward the first end 10a. This defines a circulation direction of the spontaneous emission light and the stimulated emission light in the fiber laser 1.

The output coupler (second coupler) 38 splits the light (spontaneous emission light and stimulated emission light) passing through the PM fiber (polarization plane maintaining unit) 22e toward the second end 10b and the outside (optical output).

A description will now be given of an operation of the first embodiment.

The pump laser 32 emits the pump light. The pump light passes through the WDM coupler 34, the PM fiber 22b, the single mode fiber 24, and the PM fiber 22a, and is fed to the EDF 10.

The EDF 10 receives the pump light at the first end 10a. Though the erbium in the EDF 10 is excited by the pump light, the erbium later returns to the ground state. On this occasion, the spontaneous emission light is emitted from the EDF 10. The spontaneous emission light is emitted from the first end 10a and the second end 10b. However, the spontaneous emission light emitted from the second end 10b cannot pass the isolator 36, and is thus neglected.

The spontaneous emission light emitted from the first end 10a passes through the PM fiber 22a, the single mode fiber 24, the PM fiber 22b, the WDM coupler 34, and the PM fiber 22c, and is fed to the analyzer 35. The analyzer 35 passes only light having the predetermined polarization plane. The analyzer 35 serves to check whether the light which has passed through the PM fiber 22c has the predetermined polarization plane. When the light which has passed through the PM fiber 22c passes through the analyzer 35, the light then passes through the PM fiber 22d, the isolator 36, and the PM fiber 22e, and is fed to the output coupler 38. The light which has passed through the PM fiber 22e is split by the output coupler 38 into the light toward the second end 10b and the light toward the outside (optical output). The spontaneous emission light toward the second end 10b passes through the PM fiber 22f, and is fed to the second end 10b. The second end 10b thus receives the spontaneous emission light.

It is assumed that the pump light is continuously fed to the EDF 10 on this occasion. Then, the spontaneous emission light is fed to the second end 10b of the EDF 10, the stimulated emission is thus generated, and the stimulated emission light is generated from the first end 10a. The power of the stimulated emission light is larger than the power of the spontaneous emission light fed to the second end 10b. The EDF 10 thus provides an amplification feature.

The stimulated emission light emitted from the first end 10a is fed to the second end 10b as described above. As a result, the stimulated emission occurs on the EDF 10, and the stimulated emission light is further generated from the first end 10a. The power of the further stimulated emission light is larger than the power of the stimulated emission light fed to the second end 10b. A positive feedback is carried out in this way, and the power of the stimulated emission light emitted by the EDF 10 increases. The laser oscillation is generated in this way.

It should be noted that a part of the stimulated emission light (laser oscillation light) emitted by the EDF 10 is output to the outside (optical output) from the output coupler 38.

If the polarization plane of the laser oscillation light circulating in the resonator and the polarization direction of the analyzer inserted in the resonator do not match on this occasion, the laser oscillation is not stabilized.

In order to address this problem, the stimulated emission light (laser oscillation light) is caused to pass through the PM fibers (polarization plane maintaining units) 22a, 22b, 22c, 22d, 22e, 22f so that the polarization plane will not change.

However, even if the PM fibers are used, interference (such as a variation in the environmental temperature) may change the polarization plane, and therefore, the polarization plane of the stimulated emission light (laser oscillation light) emitted from the first end 10a and the polarization plane of the stimulated emission light fed to the second end 10b may thus not match.

The single mode fiber 24 is provided for addressing this problem.

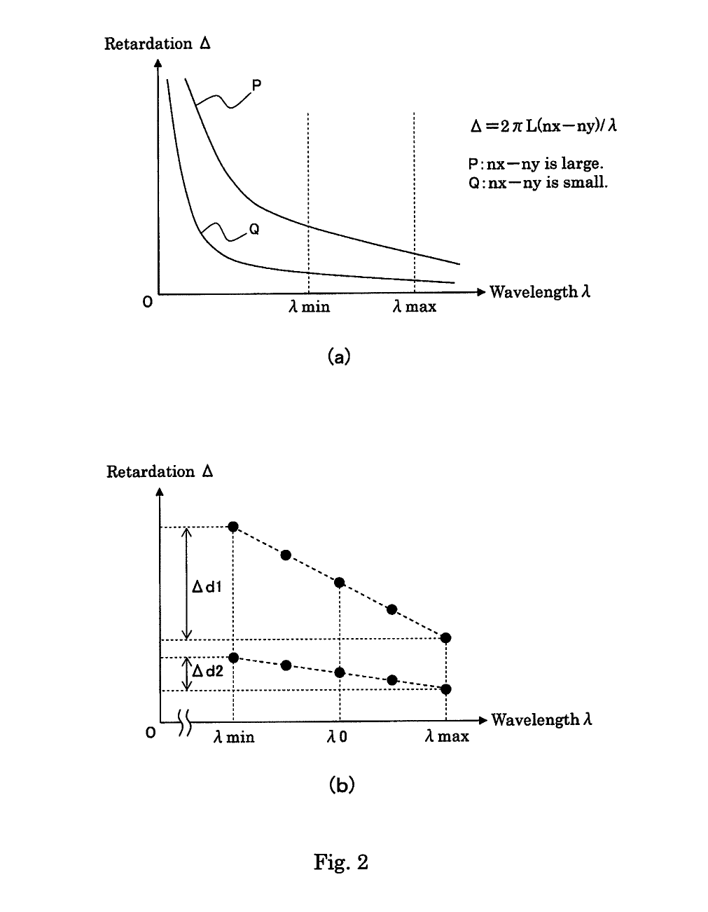

FIG. 2 describes effects of the single mode fiber (polarization plane changing unit) 24. A change (retardation A) in the polarization plane by the single mode fiber 24 is represented by the following equation where L denotes the overall length of the single mode fiber 24, nx denotes a refraction index in an x-axis direction, ny denotes a refraction index in a y-axis direction, and λ denotes the wavelength of the polarized light passing through the single mode fiber 24. It should be noted that the x axis and the y axis are principle axes of the double refraction orthogonal to each other.

Δ=2πL(nx−ny)/λ

It should be noted that the retardation A of the single mode fiber 24 is a difference in the phase between an x-axis component and a y-axis component of the polarized light generated by the passage of the polarized light through the single mode fiber 24.

FIG. 2(a) is a chart showing a relationship between the retardation A by the single mode fiber 24 and the wavelength λ of the polarized light passing through the single mode fiber 24. It should be noted that a line P corresponds to a case in which the single mode fiber 24 is used. A line Q corresponds to a case in which it is assumed that a PM fiber is used in place of the single mode fiber 24. It is assumed that both the single mode fiber 24 and the PM fiber have the same length.

The single mode fiber 24 causes a larger change in the polarization plane of the passing light compared with the PM fiber as described above. This implies that the single mode fiber 24 is larger than the PM fiber in nx−ny.

The lines P and Q are thus lines representing a general inverse proportion. Moreover, when the laser oscillation is generated on the fiber laser 1, the wavelength of the stimulated emission light takes a value equal to or more than λ min and equal to or less than λ max. The line P exists above the line Q in the range equal to or more than λ min and equal to or less than λ max.

FIG. 2(b) is an enlarged view of the lines P, Q in the range equal to or more than λ min and equal to or less than λ max. Though the lines P, Q are actually curves, they are represented as straight lines for the sake of illustration. It should be noted that the wavelength of the stimulated emission light (laser oscillation light) discretely changes in the range equal to or more than λ min and equal to or less than λ max. Thus, the lines P, Q are represented by dotted lines, and points corresponding to values which the wavelength of the stimulated emission light can take are represented by black points. Differences Δ d1 (line P), Δ d2 (line Q) between the maximum value and the minimum value of the retardation Δ in the range equal to or more than λ min and equal to or less than λ max have a relationship Δ d1>Δ d2 as shown in FIG. 2(b).

It is assumed that the stimulated emission light having a wavelength λ 0 (average of λ min and λ max) is emitted from EDF 10 at a certain time point, and the laser oscillation is stable. It is assumed that when the stimulated emission light having a wavelength λ 0 is emitted from EDF 10, the phase difference between the x component and the y component of the stimulated emission light is changed (increased by D [deg], for example) by the PM fibers 22a, 22b, 22c, 22d, 22e, 22f due to influence of interference on this occasion. This implies a change in the polarization plane, and the laser oscillation becomes unstable if this situation continues.

Even if the phase difference between the x component and the y component of the stimulated emission light increases by D [deg], if the wavelength λ of the polarized light increases from λ 0, the phase difference between the x component and the y component of the stimulated emission light decreases. The laser oscillation is stabilized at a wavelength which decreases the phase difference between the x component and the y component of the stimulated emission light by D [deg] from the case in which the wavelength of the polarized light is λ 0 (the change in the phase difference between the x component and the y component of the polarized wave is cancelled out in this case).

On this occasion, if the lines P, Q are approximated by straight lines, even if the wavelength of the stimulated emission light changes from λ 0 to λ max for the PM fiber (line Q), the phase difference between the x component and the y component of the stimulated emission light decreases by only Δ d2/2 in FIG. 2(b). If Δ d2/2<D, even if the wavelength of the stimulated emission light changes from λ 0 to λ max, the change in the phase difference between the x component and the y component of the stimulated emission light cannot be cancelled out. The laser oscillation is thus not be stabilized.

On this occasion, if the wavelength of the stimulated emission light changes from λ 0 to λ max for the single mode fiber 24 (line P), the phase difference between the x component and the y component of the polarized wave decreases by Δ d1/2(>Δ d2/2). If a relationship Δ d2/2<D<Δ d1/2 holds, and the wavelength of the stimulated emission light (laser oscillation light) increases from λ 0 (but to a wavelength less than λ max), the change in the phase difference between the x component and the y component of the polarized wave is canceled out, resulting in a stable laser oscillation.

Therefore, the single mode fiber 24 is used to promote the stability of the laser oscillation.

According to the first embodiment, the spontaneous emission light and the stimulated emission light (laser oscillation light) emitted from the first end 10a of the EDF 10 are passed through the PM fibers (polarization plane maintaining units) 22a, 22b, 22c, 22d, 22e, 22f, and are made incident to the second end 10b of the EDF 10 thereby reducing the change in the polarization plane of the spontaneous emission light and the stimulated emission light.

Moreover, even if the changes of the polarization plane of the PM fibers 22a, 22b, 22c, 22d, 22e, 22f are increased to a level at which the laser oscillation is no longer stable by influence of interference, the laser oscillation tends to become stabile. In other words, the wavelengths of the spontaneous emission light and the stimulated emission light change, and the retardation A thus changes in the single mode fiber 24, thereby cancelling out the changes in the polarization plane of the PM fibers 22a, 22b, 22c, 22d, 22e, 22f, resulting in the stable laser oscillation.

On this occasion, with respect to the wavelengths of the spontaneous emission light and the stimulated emission light, the change in the retardation Δ in the single mode fiber 24 is larger than the retardation Δ of a PM fiber, and providing the fiber laser 1 with the single mode fiber 24 thus increases the possibility of canceling out the changes in the polarization plane of the PM fibers 22a, 22b, 22c, 22d, 22e, 22f.

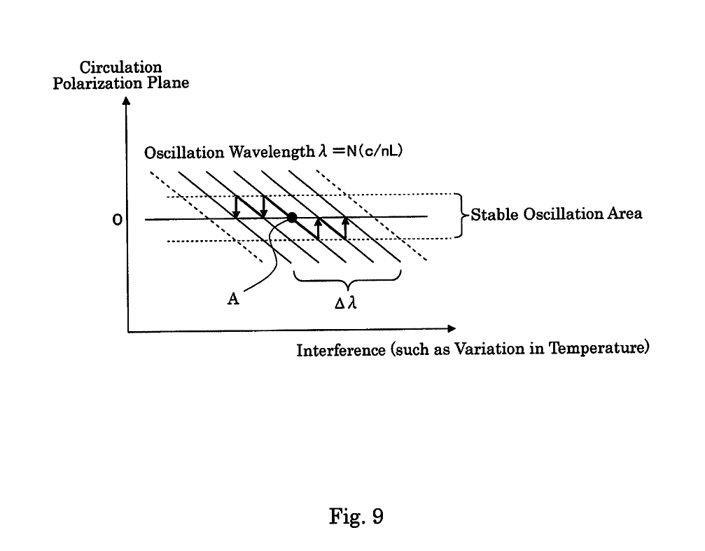

A supplementary description will now be given of the principle of the stable operation. An element which presents a large dispersion in the polarization characteristic with respect to the wavelength is inserted into a laser resonator, thereby providing a phase change sufficiently larger than the phase change of the resonator. The polarization state and the gain in the resonator are automatically compensated by the change of the oscillation wavelength for a more stable oscillation state of the light circulating in the resonator during the laser oscillation, resulting in a stable oscillation state being maintained. The oscillation wavelength F is given by F=N(c/nL) where N is an integer, c is the light velocity, n is a refraction index of a medium constructing the resonator, and L is a resonator length, and the refraction index n changes according to the optical power density in the resonator. The oscillation takes place at a wavelength which satisfies the phase oscillation condition and gives the largest loop gain within a range of Δ λ where the loop gain is equal to or more than 1 (refer to a point A in FIG. 9). It should be noted that FIG. 9 is a chart describing the principle of the stable oscillation. When the environmental temperature changes, the effect of the medium which presents a large dispersion in the polarization characteristic according to the wavelength in the resonator as shown in FIG. 9 enables a large change in the polarization state of the light in the resonator according to a small change in the oscillation wavelength, compared with a resonator in which a large wavelength dispersion element is not inserted, and it is thus possible to shift the oscillation wavelength to a more stable wavelength so that the circulation polarization plane is always 0, thereby automatically compensating the polarization state in the resonator, resulting in a stable oscillation state being maintained. Moreover, though it is conceivable to use a polarization mode dispersion element intended for temperature which has an inverse characteristic according to temperature for the compensation, the present invention is effective for any interference which is not limited to the temperature (even for a case in which the polarization mode dispersion characteristic according to interference is unknown).

Moreover, if a mode-locked oscillation is obtained by inserting a saturable absorber as a mode locker in a resonator, a stabilizing effect in the oscillation even increases further according to the present invention.

A brief description will now be given of the mode-locked oscillation. If phases of respective modes do not match upon a start of the oscillation, the optical power is small, and is absorbed by the saturable absorber, and the pulse oscillation will thus not start. If the phases gradually come to match, the pulse peak power increases, a mode lock mechanism in which the loss in the resonator decreases, and a transmission through the saturable absorber occurs comes to present, and a pulse oscillation is provided. In other words, as the variation in phase among the modes decreases, the peak intensity increases, the loss in the resonator decreases, and the oscillation of pulses having a small variation in phase is thus promoted. However, it is necessary for obtaining a stable pulse oscillation to maintain constant polarization state in the resonator, and a stable oscillation is prevented by a change in the polarization state due to a nonlinear double refraction of the optical fiber caused by a large optical power during the pulse oscillation. Though a mechanism which selects a mode which presents a small variation in phase and carries out oscillation automatically acts during the mode-locked oscillation, if the resonator length is changed, or the polarization is rotated by a change in the external temperature, the conventional configuration cannot compensate the change in the nonlinear double refraction, the polarization state of the circulating optical pulse starts deviating from the polarization direction of an analyzer inserted in the resonator, the loss in the resonator increases, the mode-locked oscillation thus becomes unstable, and the pulse oscillation can finally stop generally.

However, the present invention has the polarization plane changing unit which presents a large change in the polarization plane of the transmitting light according to the wavelength in the resonator, the phase in the resonator can be changed largely according to a small change in the oscillation wavelength by inserting the element which presents a large dispersion in the polarization characteristic according to the wavelength in the resonator in the same way as in the continuous oscillation, and the mode lock mechanism can thus automatically change the oscillation wavelength toward a state in which the phase variation among modes decreases. As a result, the polarization state in the resonator is maintained constant, resulting in a stable operation. Further, providing the polarization plane changing unit which presents a large change in the polarization plane of the transmitting light according to the wavelength in the resonator enables compensation of a variation of the polarization plane in the resonator caused by a nonlinear double refraction specific to the pulse oscillation so that a stable oscillation state is attained by the fiber laser itself changing the laser oscillation wavelength.

### Second Embodiment

A second embodiment is obtained by changing the shape of the single mode fiber 24 according to the first embodiment.

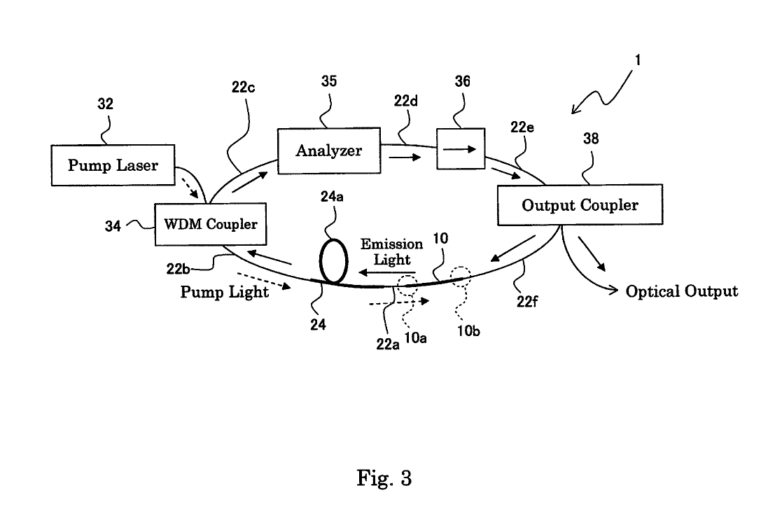

FIG. 3 is a diagram showing a configuration of the fiber laser 1 according to the second embodiment of the present invention.

The single mode fiber 24 according to the second embodiment includes a first circulation portion 24a which is circled with a radius of a predetermined length. Though the first circulation portion 24a circulates only one turn in FIG. 3, the circulation may be multiple turns. The other components are the same as those of the first embodiment, and hence a description thereof is omitted.

An operation of the second embodiment is the same as that of the first embodiment, and hence a description thereof is omitted.

According to the second embodiment, there are provided the same effects as in the first embodiment. Moreover, the bend of the first circulation portion 24a of the single mode fiber 24 provides a larger effect of the double refraction than that of the case without the bend. Thus, the change in the retardation A increases in the single mode fiber 24 according to the wavelength of the spontaneous emission light and the stimulated emission light, thereby promoting the stability of the laser oscillation.

### Third Embodiment

A third embodiment is obtained by changing the shape of the single mode fiber 24 according to the second embodiment.

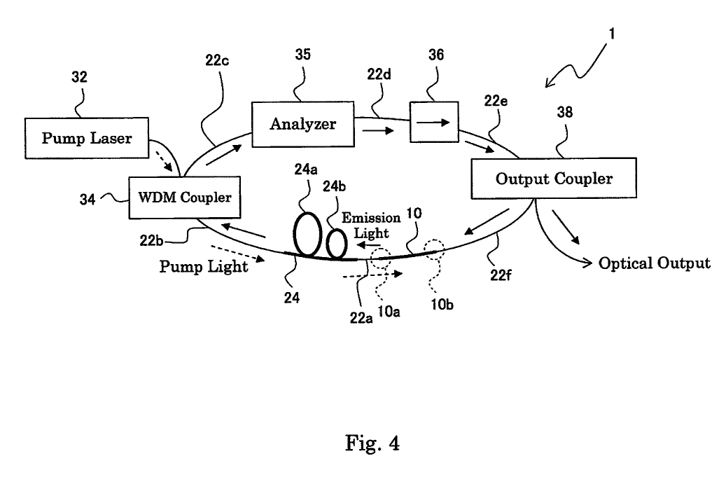

FIG. 4 is a diagram showing a configuration of the fiber laser 1 according to the third embodiment of the present invention.

The single mode fiber 24 according to the third embodiment includes the first circulation portion 24a which is circled with the radius of the predetermined length, and a second circulation portion 24b which is circled with a radius shorter than the predetermined length. Though the first circulation portion 24a and the second circulation portion 24b circulate only one turn in FIG. 4, the circulation may be multiple turns. The other components are the same as those of the first embodiment, and hence a description thereof is omitted.

An operation of the third embodiment is the same as that of the first embodiment, and hence a description thereof is omitted.

According to the third embodiment, there are provided the same effects as in the first embodiment. Moreover, the bends of the first circulation portion 24a and the second circulation portion 24b of the single mode fiber 24 provide a larger effect of the double refraction than that of the case without the bends. Moreover, the connection between the first circulation portions 24a and the second circulation portion 24b provides a larger double refraction effect compared with a case having only the first circulation portion 24a or the second circulation portion 24b. Thus, the change in the retardation Δ increases in the single mode fiber 24 according to the wavelength of the spontaneous emission light and the stimulated emission light, thereby promoting the stability of the laser oscillation.

### Fourth Embodiment

A fourth embodiment is obtained by replacing the single mode fiber 24 according to the first embodiment with a double refraction material 25.

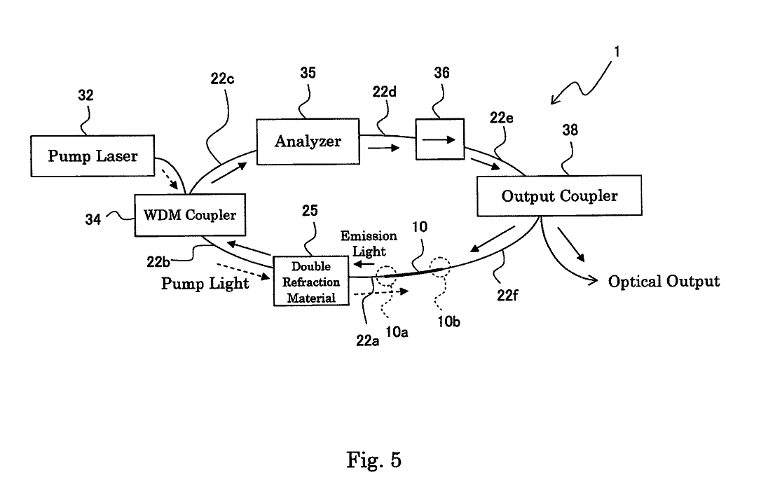

FIG. 5 is a diagram showing a configuration of the fiber laser 1 according to the fourth embodiment of the present invention.

The double refraction material 25 according to the fourth embodiment provides a double refraction effect, and is calcite, YVO4, or α-BBO, for example. The other components are the same as those of the first embodiment, and hence a description thereof is omitted.

An operation of the fourth embodiment is the same as that of the first embodiment, and hence a description thereof is omitted.

According to the fourth embodiment, there are provided the same effects as in the first embodiment.

### Fifth Embodiment

A fifth embodiment is obtained by replacing the single mode fiber 24 according to the first embodiment with a PM fiber (polarization plane changing unit) 26.

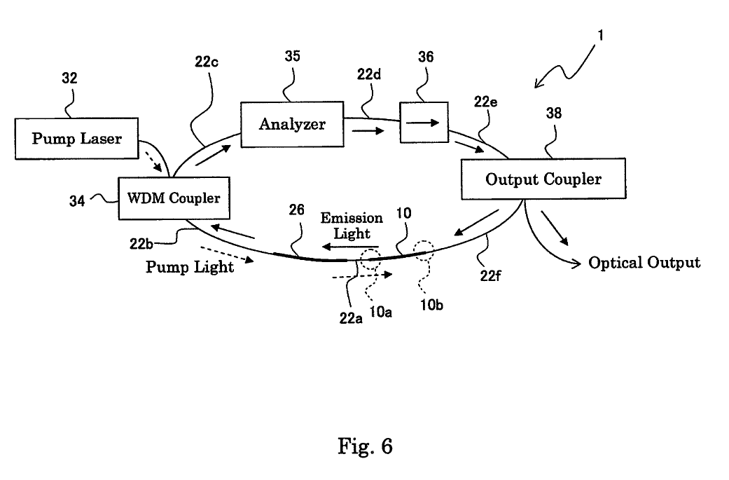

FIG. 6 is a diagram showing a configuration of the fiber laser 1 according to the fifth embodiment of the present invention.

The PM fiber (polarization plane changing unit) 26 according to the fifth embodiment is a second polarization plane maintaining fiber. It is conceivable to unify the EDF 10 and the PM fiber 26. Moreover, the PM fiber 26 has a polarization axis different from the polarization axis of the first polarization plane maintaining fibers (PM fibers 22a, 22b, 22c, 22d, 22e, 22f). The other components are the same as those of the first embodiment, and hence a description thereof is omitted.

An operation of the fifth embodiment is the same as that of the first embodiment, and hence a description thereof is omitted.

According to the fifth embodiment, the polarization axis of the PM fiber 26 is different from the polarization axis of the first polarization plane maintaining fibers (PM fibers 22a, 22b, 22c, 22d, 22e, 22f), and the PM fiber 26 thus provides a larger double refraction effect. It is thus possible to largely change the polarization plane of the light which has passed through the PM fiber 22a by the PM fiber (polarization plane changing unit) 26. Therefore, the change in the retardation Δ increases in the PM fiber (polarization plane changing unit) 26 according to the wavelength of the spontaneous emission light and the stimulated emission light, thereby promoting the stability of the laser oscillation.

### Sixth Embodiment

A sixth embodiment is obtained by replacing the single mode fiber 24 according to the first embodiment with PM fibers (polarization plane changing units) 26a, 26b.

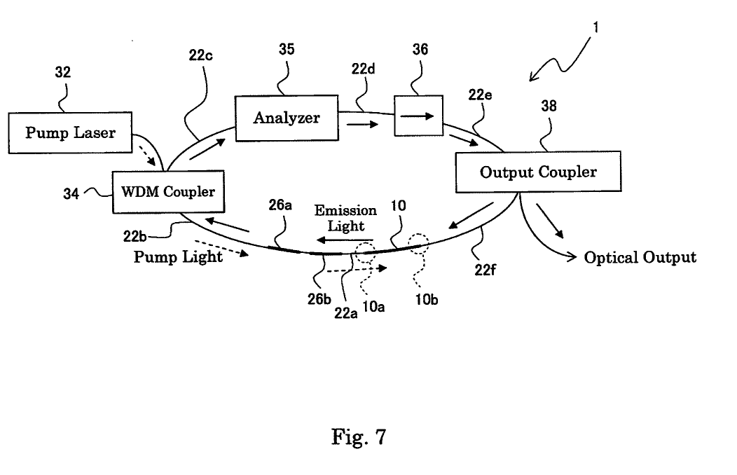

FIG. 7 is a diagram showing a configuration of the fiber laser 1 according to the sixth embodiment of the present invention.

The PM fibers (polarization plane changing units) 26a, 26b according to the sixth embodiment are respectively a second polarization plane maintaining fiber and a third polarization plane maintaining fiber. It is conceivable to unify the EDF 10 and the PM fibers 26a, 26b. Moreover, the PM fibers 26a, 26b have a polarization axis different from the polarization axis of the first polarization plane maintaining fibers (PM fibers 22a, 22b, 22c, 22d, 22e, 22f). Moreover, the polarization axis of the PM fiber 26a and the polarization axis of the PM fiber 26b are different from each other. The other components are the same as those of the first embodiment, and hence a description thereof is omitted.

An operation of the sixth embodiment is the same as that of the first embodiment, and hence a description thereof is omitted.

According to the sixth embodiment, the polarization axes of the PM fibers 26a, 26b are different from the polarization axis of the first polarization plane maintaining fibers (PM fibers 22a, 22b, 22c, 22d, 22e, 22f), and therefore, the PM fiber 26 provides a larger double refraction effect. Moreover, the connection between the PM fiber 26a and the PM fiber 26b which are different in polarization axis from each other provides a larger double refraction effect. It is thus possible to largely change the polarization plane of the light which has passed through the PM fiber 22a by the PM fibers (polarization plane changing units) 26a, 26b. Thus, the change in the retardation Δ increases in the PM fibers (polarization plane changing units) 26a, 26b according to the wavelength of the spontaneous emission light and the stimulated emission light, thereby promoting the stability of the laser oscillation.

### Seventh Embodiment

A seventh embodiment corresponds to a configuration constructed by removing the PM fiber 22a and the single mode fiber 24 according to the first embodiment, and inserting a PM fiber (polarization plane changing unit) 28 between the analyzer 35 and the PM fiber 22d.

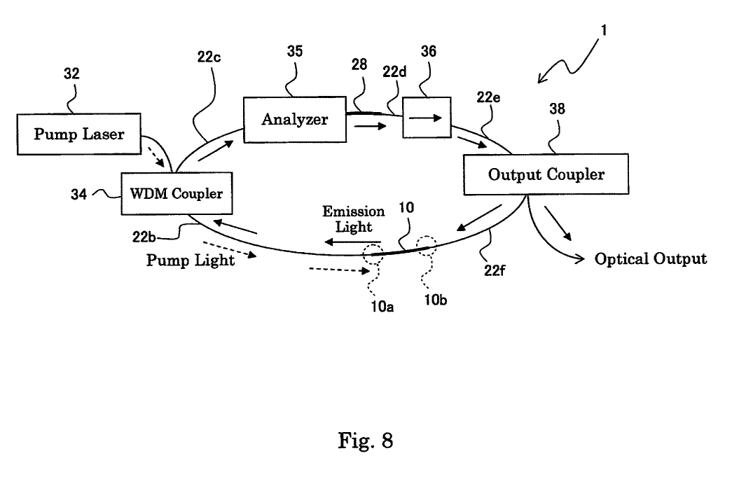

FIG. 8 is a diagram showing a configuration of the fiber laser 1 according to the seventh embodiment of the present invention. The PM fiber 22b connects the first end 10a of the EDF 10 and the WDM coupler 34 with each other. The PM fiber (polarization plane changing unit) 28 is a fourth polarization plane maintaining fiber. The polarization axis of the PM fiber (polarization plane changing unit) 28 is different from the polarization axis of the analyzer 35. It is conceivable to unify the EDF 10 and the PM fiber 28.

An operation of the seventh embodiment is the same as that of the first embodiment, and hence a description thereof is omitted.

According to the seventh embodiment, the polarization axis of the PM fiber 28 is different from the polarization axis of the analyzer 35, and the PM fiber 28 thus provides a larger double refraction effect. It is thus possible to largely change the polarization plane of the light which has passed through the analyzer 35 by the PM fiber (polarization plane changing unit) 28. Thus, the change in the retardation Δ increases in the PM fiber (polarization plane changing unit) 28 according to the wavelength of the spontaneous emission light and the stimulated emission light, thereby promoting the stability of the laser oscillation.

1. A fiber laser comprising:
an optical amplification unit that has a first end and a second end, receives pump light, and emits spontaneous emission light from the first end, and receives the spontaneous emission light at the second end, and emits stimulated emission light from the first end; and
a light passing unit that connects the first end and the second end with each other, and passes the spontaneous emission light and stimulated emission light, wherein the light passing unit comprises:
a polarization plane maintaining unit that presents a small change in the polarization plane of the passing light according to a change in the wavelength of the passing light; and
a polarization plane changing unit that presents a large change in the polarization plane of the passing light according to a change in the wavelength of the passing light.

2. The fiber laser according to claim 1, wherein the polarization plane maintaining unit is a first polarization plane maintaining fiber.

3. The fiber laser according to claim 1, wherein the polarization plane changing unit is an optical fiber that includes a first circulation unit which is circled with a radius of a predetermined length.

4. The fiber laser according to claim 3, wherein the polarization plane changing unit is an optical fiber that further includes a second circulation unit which is circled with a radius shorter than the predetermined length.

5. The fiber laser according to claim 1, wherein the polarization plane changing unit is a double refraction material.

6. The fiber laser according to claim 2, wherein the polarization plane changing unit includes a second polarization plane maintaining fiber that has a polarization axis different from a polarization axis of the first polarization plane maintaining fiber.

7. The fiber laser according to claim 6, wherein the polarization plane changing unit further includes a third polarization plane maintaining fiber that has a polarization axis different from the polarization axes of the first polarization plane maintaining fiber and the second polarization plane maintaining fiber.

8. The fiber laser according to claim 1, comprising an analyzer that allows only light having a predetermined polarization plane to pass, wherein the polarization plane changing unit includes a fourth polarization plane maintaining fiber that has a polarization axis different from the polarization axis of the analyzer.

9. The fiber laser according to claim 1, wherein the optical amplification unit and the polarization plane changing unit are unified.

10. The fiber laser according to claim 1, comprising:
a pump light source that emits the pump light;
a first coupler that allows the pump light to pass toward the first end, and allows the light emitted from the first end to pass toward the second end;
a second coupler that splits the light passing through the polarized plane maintaining unit toward the second end and the outside; and
an analyzer that allows only light having a predetermined polarization plane to pass,
wherein the polarization plane maintaining unit includes an isolator that passes the light emitted from the first end toward the second end, and does not pass the light emitted from the second end toward the first end.
